(19) United States
(12) Patent Application Publication
(10) Pub. No.: US 2011/0223953 A1
(43) Pub. Date: Sep. 15, 2011

(54) APPARATUS FOR DIRECT COMMUNICATION IN A WIRELESS SYSTEM AND METHOD THEREOF

(75) Inventors: Hyun Woo Lee, Anyang-si (KR); Han Gyu Cho, Anyang-si (KR); Yeong Hyeon Kwon, Seoul (KR)

(73) Assignee: LG ELECTRONICS INC.

(21) Appl. No.: 13/045,472

(22) Filed: Mar. 10, 2011

Related U.S. Application Data
(60) Provisional application No. 61/314,167, filed on Mar. 16, 2010.
(60) Provisional application No. 61/313,806, filed on Mar. 15, 2010.

(30) Foreign Application Priority Data
Feb. 9, 2011 (KR) 10-2011-0011542

(51) Int. Cl. H04W 72/04

(52) U.S. Cl. 455/509

(57) ABSTRACT

An apparatus for direct communication in a wireless communication system and method thereof are disclosed, by which a communication is efficiently enabled with a low power. In performing a direct communication in a first terminal of a wireless communication system, the present invention includes receiving a resource allocation information on a resource allocated to the direct communication from a base station and performing the direct communication with a second terminal using the allocated resource. In this case, the allocated resource is defined in either an uplink resource region of the base station or a downlink resource region of the base station and the allocated resource is divided into a transmission region for the direct communication and a receipt region for the direct communication.

### CROSS-REFERENCE TO RELATED APPLICATIONS

Pursuant to 35 U.S.C. §119, this application claims the benefit of earlier filing date and right of priority to Korean Patent Application No. 10-2011-0011542, filed on Feb. 9, 2011, and U.S. Provisional Patent Application Nos. 61/314,167, filed on Mar. 16, 2010, and 61/313,806, filed on Mar. 15, 2010, the contents of which are incorporated by reference herein in their entirety.

### BACKGROUND OF THE INVENTION

1. Field of the Invention

The present invention relates to a wireless communication system, and more particularly, to an apparatus for direct communication in a wireless communication system and method thereof.

2. Discussion of the Related Art

Generally, a communication between terminals located in a near distance in-between can be defined as a peer-to-peer type. In the peer-to-peer communication, a random access scheme between communication subjects is defined and the communication subjects perform the communications in accordance with a protocol. And, in the peer-to-peer communication, it is not necessary to consider whether a communication subject is connected to a public internet network.

On the contrary, a communication in a cellular network should be defined as a communication between a base station (i.e., an entity equivalent to the base station) and a terminal. And, all communication actions are controlled by the base station or the entity equivalent to the base station. For instance, a base station controls all actions (e.g., a data transmission power of the terminal, etc.) of a mobile terminal. In particular, the cellular network is configured to obtain maximum throughput by limiting operations of all terminals by a predetermined rule. Yet, this rule may be inefficient in accordance with an application or a channel configuration of terminal. For instance, in case that a channel configuration of a terminal is vulnerable, limitation is put on using an optimal communication path by finding a new access path.

FIG. 1 is a diagram for an example of a cellular network.

Referring to FIG. 1, a first terminal MS (mobile station) 1 makes a request for a communication with a second terminal MS 2 to a base station BS. Having received the request, the base station BS allocates uplink (UL) and downlink (DL) resources to the first terminal MS 1 and the second terminal MS 2. Thereafter, each of the first terminal MS 1 and the second terminal MS 2 performs a communication with the base station BS. And, the first terminal MS 1 and the second terminal MS 2 are able to perform communications in-between through the base station. FIG. 1 schematically shows a communication time, order, uplink, downlink and the like of each of the first and second terminals MS 1 and MS 2 with the base station for clarity, which can vary in accordance with a scheduling of the base station, a state of each terminal, a transmission size of each terminal and the like. The procedure shown in FIG. 1 is schematically illustrated and signals including additional control information, measurement information and the like can be transceived between the terminal and the base station.

In the conventional communication system shown in FIG. 1, communications between terminals are always performed via the base station.

Generally, a path loss or a propagation loss, which occurs in the course of transmission, increases in proportion to a distance. To compensate for such a loss, a transmitter needs to transmit a power with more power. Therefore, although a specific terminal is located closer than a base station or a communication with a terminal in good channel status is necessary, it may happen that a signal is transmitted perform a communication via the base station using a high power, which raises battery consumption of a terminal. Moreover, in aspect of the base station, an unnecessary transceiving of a simple forwarding type is performed. As such a wireless communication system as 3GPP LTE, IEEE P802.16, and the like considers a cell having a cell radius of maximum 100 km, that problem gets more serious. Although a communication according to a related art has been developed by focusing on throughput, energy aspect becomes more important. Specifically, the more the communication of M2M (machine to machine) or machine type gets developed, the more important how to use energy efficiently becomes.

However, as mentioned in the above description, a wireless communication system according to a related art consumes a considerable amount of energy for communications between terminals located in short range and also causes an unnecessary operation to a base station.

### SUMMARY OF THE INVENTION

Accordingly, the present invention is directed to an apparatus for direct communication in a wireless communication system and method thereof that substantially obviate one or more problems due to limitations and disadvantages of the related art.

An object of the present invention is to provide an apparatus for direct communication in a wireless communication system and method thereof, by which a communication is efficiently enabled with a low power.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for performing a direct communication, which is performed by a first terminal in a wireless communication system, according to the present invention includes the steps of receiving a resource allocation information on a resource allocated to the direct communication from a base station and performing the direct communication with a second terminal using the allocated resource. In this case, the allocated resource is defined in either an uplink resource region of the base station or a downlink resource region of the base station and the allocated resource is divided into a transmission region for the direct communication and a receipt region for the direct communication.

Preferably, the allocated resource is reused for a communication between the base station and a third terminal.

Preferably, the allocated resource is reused for a communication between a third terminal and a fourth terminal.

Preferably, the method further includes the steps of performing a channel quality measurement on neighbor terminals, transmitting a result of the measurement to the base station, and receiving an information on the second terminal to perform the direct communication with the first terminal from the base station, wherein the second terminal is determined using the measurement information.

More preferably, the method further includes the step of receiving a list of the neighbor terminals from the base station.

Preferably, the method further includes the steps of transmitting a first channel for informing neighbor terminals of an existence of the first terminal and receiving a second channel from the second terminal in response to the first channel.

Preferably, the method further includes the step of transmitting a direct communication request to the base station.

In another aspect of the present invention, a method of supporting a direct communication in a base station of a wireless communication system includes the steps of determining a resource allocated to the direct communication in a manner of defining a resource region to use for the direct communication on either an uplink resource region and a downlink resource region and dividing the defined resource region into a transmission region and a receipt region for the direct communication and transmitting a resource allocation information on the allocated resource to a first terminal.

In another aspect of the present invention, a first terminal in a wireless communication system includes a receiving module configured to receive a resource allocation information on a resource allocated to a direct communication from a base station and a processor configured to perform the direct communication with a second terminal using the allocated resource. In this case, the allocated resource is defined in either an uplink resource region of the base station or a downlink resource region of the base station and the allocated resource is divided into a transmission region for the direct communication and a receipt region for the direct communication.

In a further aspect of the present invention, a base station in a wireless communication system includes a processor configured to determine a resource allocated to the direct communication in a manner of defining a resource region to use for the direct communication on either an uplink resource region and a downlink resource region and dividing the defined resource region into a transmission region and a receipt region for the direct communication and a transmitting module configured to transmit a resource allocation information on the allocated resource to a first terminal.

Accordingly, the present invention provides the following effect and/or advantage.

First of all, the present invention enables a direct communication to be efficiently performed with a low power.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for an example of a cellular network;

FIGS. 2(a)-2(b) are diagrams for a difference between a communication method according to a related art and a direct communication method;

FIG. 3 is a diagram for a direct communication method according to an embodiment of the present invention;

FIGS. 4(a)-4(b) are diagrams for a resource reuse;

FIG. 5 is a diagram for one example of resource allocation for a direct communication; and

FIG. 6 is a diagram for configurations of mobile and base stations, in which embodiments of the present invention are implemented, according to another embodiment of the present invention.

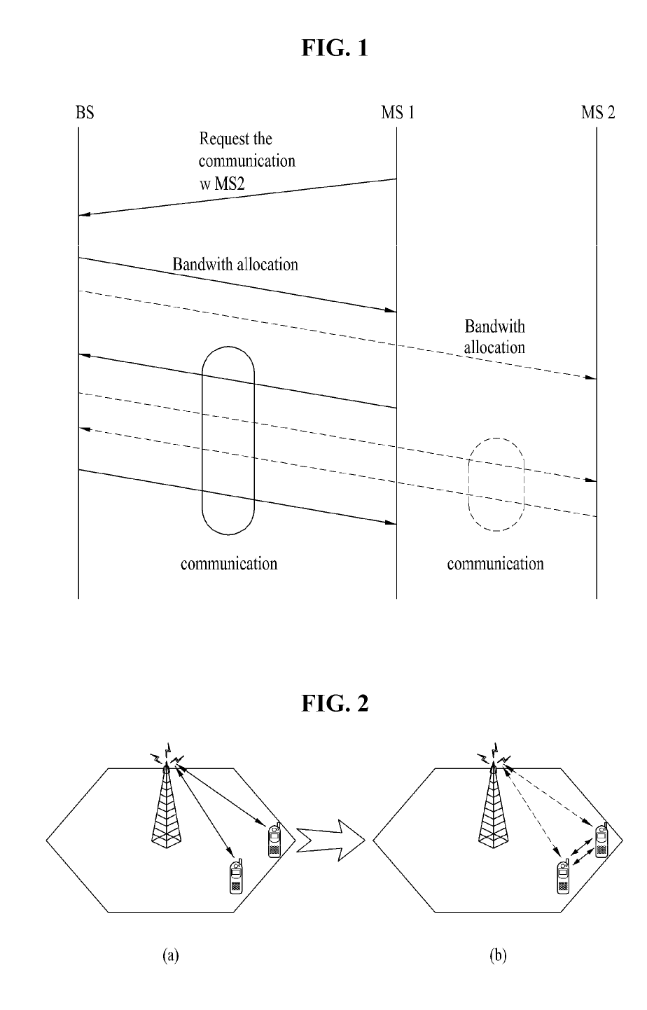

### DETAILED DESCRIPTION OF THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes IEEE (institute of electrical and electronics engineers) 802.16 system, the following descriptions are applicable to such a random mobile communication system as 3GPP (3^{rd} generation partnership project) LTE (long term evolution) system and the like except unique features of the IEEE 802.16 system.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS) and the like. And, assume that a base station is a common name of such a random node of a network stage communicating with a terminal as a Node B (NB), an eNode B (eNB), a base station (BS), an advanced base station (ABS) and the like.

In the following description, differences between a communication method according to a related art and a direct communication method according to an embodiment of the present invention are explained with reference to FIG. 2.

FIG. 2 is a diagram for a difference between a communication method according to a related art and a direct communication method.

Referring to FIG. 2 (a), in a communication system according to a related art, mobile stations always perform communications via a base station. On the contrary, referring to FIG. 2 (b), if a direct communication between mobile stations is possible (e.g., if mobile stations are located in a manner of being geographically adjacent to each other, if a channel status between mobile stations is good, etc.), the mobile stations are still controlled by the base station. Yet, substantial data, control information related to data, network management and control information between mobile stations and the like are exchanged by the direct communications between mobile stations.

In particular, for the establishment of a direct link between at least two mobile stations requesting communications, a base station instructs a direct communication between two mobile stations, actually allocates predetermined resources for the direct communication between the two mobile stations, and then informs the two mobile stations of the resource allocation. Alternatively, after a primary mobile station (primary MS) has been determined, a base station exchanges associated information with the primary mobile station only and a communication between mobile stations can be performed via the primary mobile station.

Under the direction or instruction of a base station, real data are exchanged between mobile stations without passing through the base station. In doing so, all communication can be performed by the direct communication between mobile stations, real data and minimum control information associated with the real data are preferably transceived between the mobile stations and necessary control information preferably keeps being transceived with the base station. In particular, if a direct communication according to the present invention is performed between mobile stations, it does not mean that a connection and communication with a base station are excluded. In more particular, direct communication request and response information, scheduling information (resource allocation information), security information and information required for performing a direct communication between mobile stations can be exchanged between a base station and a mobile station performing the direct communication prior to the direct communication between mobile stations. The information required for performing the direction communication between mobile stations can include information indicating what kind of direct communication method is used and parameters for specifying a direct communication. The parameters for specifying the direct communication can include overall PHY (physical) and MAC layer related parameters such as a maximum power, a coverage, a data rate, a modulation and coding scheme (MCS), an MIMO (multiple input multiple output) scheme and mode, an antenna configuration, a frame structure, a subframe configuration and the like. If necessary, specific control informations can be exchanged between a base station and a mobile station in the course of a direct communication between mobile stations.

A communication between mobile stations according to an embodiment of the present invention is taken as an example for the description, by which the present invention is non-limited. An entity for performing a direct communication can include such a node for performing a control function as a relay node and the like and can become a portion of a sort of a local network such as a node having representation of adhoc network.

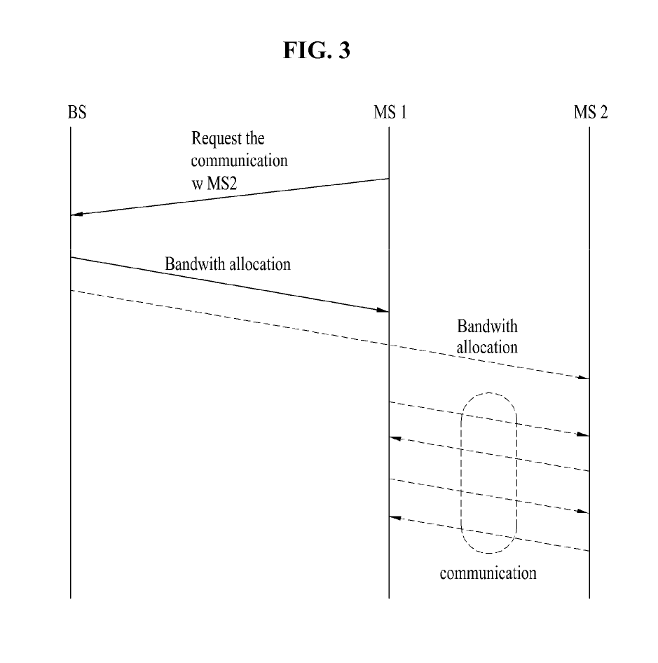

In the following description, a direct communication method according to an embodiment of the present invention is explained with reference to FIG. 3.

FIG. 3 is a diagram for a direct communication method according to an embodiment of the present invention.

Referring to FIG. 3, a first mobile station MS 1 makes a request for a direct communication with a second mobile station MS 2 to a base station BS. Although FIG. 3 exemplarily shows that the mobile station makes the request for the direct communication to the base station, the base station BS is able to make a request for the mobile station to perform a direct communication.

Having received the direct communication request, the base station BS allocates resources for the direct communication between the first mobile station MS 1 and the second mobile station MS 2. In doing so, a step of inquiring the second mobile station MS 2 of an intention for the direct communication and a step of sending a result of the inquiry to the first mobile station MS 1 as a response can be further added. In this case, the added steps are performed by the base station. Subsequently, the base station transmits resource allocation information on a resource region allocated to the direct communication. In this case, the base station is able to independently signal the resource allocation information to each of the first mobile station Ms1 and the second mobile station MS 2. Alternatively, the base station is able to signal the resource allocation information in common with the first mobile station MS 1 and the second mobile station MS 2. An indication about the direct communication can be included in the resource allocation information. And, the base station BS is able to allocate a resource for the base station to transmit control information.

Afterwards, the first mobile station MS 1 and the second mobile station MS 2 are able to perform the direct communication in-between by minimizing unnecessary communications with the base station BS. For clarity and convenience, FIG. 3 schematically shows a communication time, a communication order and a time and order of uplink and downlink between the base station BS and each of the first and second mobile stations MS 1 and MS 2 and a communication time, a communication order and a time and order of uplink and downlink between mobile stations, which can vary in accordance with a scheduling of the base station BS, a state of each mobile station, a transmission size of each mobile station and the like. Moreover, since the above-described procedure is schematized for clarity and convenience, signals such as additional control information, measurement information and the like can be transceived between the mobile station and the base station and/or between the mobile stations.

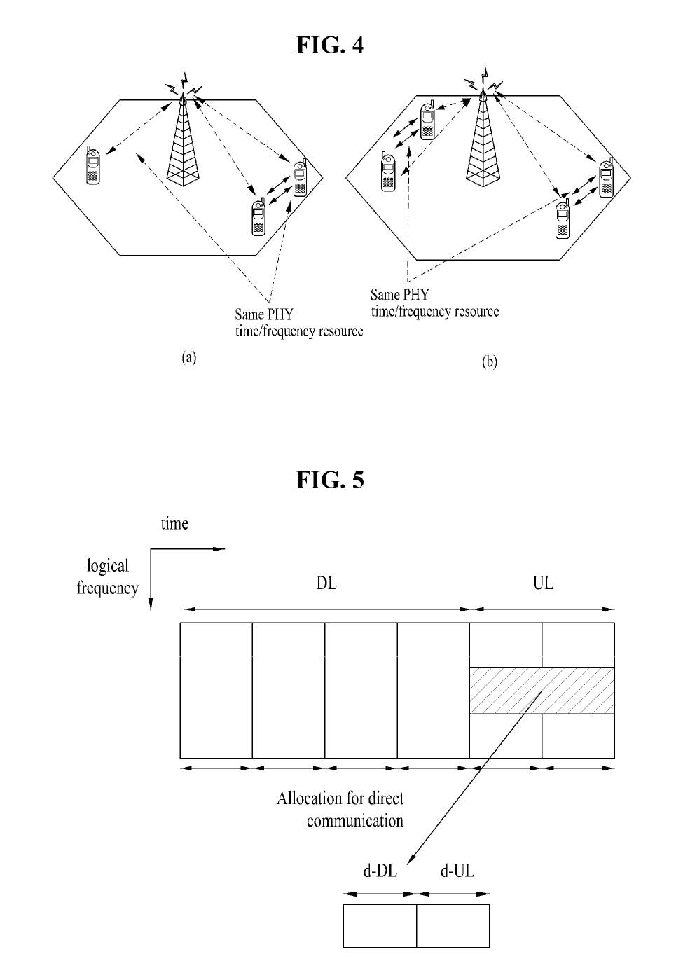

In the following description, a method for a base station to allocate a resource to use for a direct communication is explained with reference to FIG. 4 and FIG. 5.

First of all, a resource used for a direct communication is defined within a bandwidth used between a base station and a mobile station or can be defined within a bandwidth different from the former bandwidth used between the base station and the mobile station. In this case, a bandwidth used between a base station and a mobile station is called in-band, while a bandwidth different from the former bandwidth used between the base station and the mobile station is called out-band. The in-band means that multi-carriers used between the base station and the mobile station are all included. In particular, a specific multi-carrier can be used for the direct communication.

If a resource used for a direct communication is defined on the out-band, the direct communication can be performed using a conventional system or another system. For instance, an 802.16m mobile station is operable in a center frequency different from that of a conventional system using 802.16m physical and MAC layers. For another instance, an 802.16m mobile station is operable in a center frequency different from that of a conventional system using such a system as Wi-Fi, Zigbee and the like except the 802.16m system. Yet, in case that the out-band is used, it is difficult for a base station to efficiently control the out-band.

In case that a direction communication is performed on the in-band, a specific part within a bandwidth of a base station is allocated to the direct communication, which can be called a resource localization. In this case, the resource localization means to reserve or allocate a resource for the direct communication but does not mean consecutive physical subcarriers. A resource allocated to the direct communication can include contiguous subcarriers or distributed sub carriers.

In this case, the direct communication, which is performed using the in-band, can use the same physical and MAC layer structures of a communication system using the corresponding band or is able to define new physical and MAC layer structures for the in-band direct communication. Alternatively, the in-band direct communication is able to reuse the physical and MAC layer structures of such a conventional heterogeneous system as WiFi, Zigbee and the like. And, the in-band direct communication enables a base station to control mobile stations and resources more efficiently.

In case that a direct communication is performed on an in-band, it is possible to reuse resources. FIG. 4 is a diagram for a resource reuse. FIG. 4 (a) shows an example of using the same physical resource for a direct communication and a general communication. A base station is able to use a resource allocated to a direct communication for mobile stations located geographically distant from former mobile stations performing the direct communication or mobile stations that use a channel having no correlation with the former mobile stations performing the direct communication. Although the same resource is double-used within a cell, it is able to cancel or minimize the corresponding interference. In particular, a predetermined group of communication entities uses a specific resource in a predetermined physical or logical space, while a group of other entities reuses the corresponding resource without having influence thereon. In order to enable such a structure to operate well, a base station should be involved in the interactions (e.g., interference, coordination, etc.) between groups or the communication entity groups should cooperate with each other.

FIG. 4(b) shows an example of a reuse of the same physical resource between direct communications. Referring to FIG. 4(b), a resource allocated to a specific direct communication can be reallocated to another direct communication for mobile stations located geographically distant from the former mobile stations performing the specific direct communication or can be allocated to another direction communication for mobile stations having a channel with no correlation. Although the same resource is double-used within a cell, it is able to cancel or minimize the corresponding interference. Through the resource reuse, the cell is able to obtain such an effect as a capacity increase, a throughput increase and the like.

FIG. 5 is a diagram for one example of resource allocation for a direct communication.

Referring to FIG. 5, first of all, a resource for a direct communication is usable in a manner different from that of a conventional system. A resource for a direct communication can be allocated to a UL region of a base station only. And, the allocated resource can be divided into a transmission region for a direct communication and a receipt region for the direct communication. The transmission region can be called a direct communication uplink (d-uplink) and the receipt region can be called a direct communication downlink (d-downlink). The same overall structures, which include OFDMA parameter, frame structure, cyclic prefix length, subframe configuration, pilot pattern, resource allocation unit, resource allocation method and the like, are usable in the same manner of the related art. The overall structures can be newly configured to be optimized for the direct communication. And, it is possible to apply such a difference access scheme as CDMA and the like within the allocated resource. Moreover, the resource allocation unit includes a physical resource unit, a distributed resource unit, a contiguous resource unit or the like.

A resource used for a direct communication can be set different in accordance with a situation or status of an in-band or an out-band. For instance, in case of the in-band, a transmission region and a receipt region for a direct communication can be defined in a UL or DL resource. Moreover, the transmission region and the receipt region can define and use the same resource for an inter-mobile station communication. This can be shown in both TDD (time division duplex) and FDD (frequency division duplex).

Transmission and receipt regions should be defined on the out-band. A base station is able to directly structuralize and define a resource on the out-band. Considering that inter-coordination is required for entities or communication entity groups to perform a direct communication, a use authority is granted to the entity or the entity group by dividing the out-band resource in time, frequency, code and MIMO regions, whereby overall frequency resource utilization can be maximized.

According to the embodiment of the present invention, the case of TDD is taken as an example for the description. In case of FDD, a resource for a direct communication between mobile stations can differ from that of a conventional system in uplink and/or downlink.

In the following description, a method off determining a mobile station to perform a direct communication is explained.

First of all, in order to configure a direct communication between mobile stations, one mobile station should be able to determine to communicate with a which mobile station and should be aware what kind of influence is put on a circumference by a consequent communication network. In particular, a mobile station measures such information on a mobile station, which is adjacent or becomes a target of a direction communication, as various channel informations, power information, processing capability of a mobile station and the like and is then able to deliver the measured information to a base station. In this case, if a counterpart mobile station is an entity independent from a mobile station desiring a direct communication, i.e., if the counterpart mobile station belongs to a different owner or has no control authority, the corresponding mobile station delivers the measured information to the base station and is then controlled by the base station in establishing a communication path to a neighbor mobile station that will become the target mobile station. Therefore, such attribute to a connection between mobile stations as security, energy, QoS (quality of service) and the like can be improved.

For the above measurement, the mobile station desiring the direct communication should be capable of reading out control information exchanged between the base station and the target mobile station or such information as a control signal, a preamble, a beacon and the like. In order to enable this function, the mobile station desiring the direct communication should be able to obtain information on mobile stations possible to become neighbor mobile stations, i.e., information for identifying a signal (e.g., mobile station ID, location of control information, allocation information, etc.) from the base station. If it is impossible to obtain this information from the base station, the mobile station desiring the direct communication is bale to receive the information on the target mobile station through user's interaction. If the reception through the user's interaction is impossible as well, the corresponding mobile station analyzes a received random signal and then reports the analysis of the received random signal. Since the user's interaction is able to solve a process such as a security process for designating a target mobile station in direct and setting a communication, it does not cause a problem in performing the direct communication. On the other hand, if the mobile station desiring the direct communication is unable to obtain any information on neighbor mobile station desiring the direct communications (e.g., a mobile station of a stranger, emergency, etc.), the mobile station is able to use a signal structure for predicting an action of another mobile station. For instance, such a channel having a predetermined operational structure as a random access channel, a ranging channel, a sounding channel, a periodic ranging channel, one of various control channels, a reference/pilot channel, a data channel and the like is the target that can be measured by a mobile station. If the mobile station measures and reports those channels, the mobile station needs to deliver information on a measurement timing point (e.g., a corresponding signal structure detected subframe and OFDM symbol position, a direct time position, etc.) and information on a frequency resource position and the like to the base station together. Based on these informations, the base station determines the target mobile station and is then able to set a communication.

According to the foregoing description, a mobile station performs measurement on neighbor mobile stations and then reports the measurement to a base station. On the contrary, according to the following description, a mobile station is able to utilize a channel for direct initiation with a neighbor mobile station. In particular, a mobile station measures a predetermined channel (i.e., a measurable channel having a predetermined signal structure identifiable by a mobile station at a specific timing point) and is then able to inform the measured mobile station of a response signal on a channel equal to the measured channel or a channel defined for feedback [indication]. For instance, an air interface for supporting a direct communication is able to provide a channel for informing another mobile station of existence and a channel for informing another mobile station of recognition.

The channel for informing another mobile station of existence includes such a channel, which has a structure a random mobile station is able to randomly transmit, as a sounding channel, a ranging channel and the like. The transmission of this channel is performed in a manner that a direct communication enabled mobile station transmits a signal to be recognizable by a neighbor mobile station.

The channel for informing another mobile station of recognition is the channel usable when a specific mobile station detects a signal of another mobile station and desires a communication with the corresponding mobile station. This channel has a contention based channel structure and is preferably transmitted by including an identity of the detected signal. If a recognition is transmitted using the same channel, the same signal can be transmitted by being replicated. For instance, if a channel carries a preamble sequence only, it is able to consider that the same preamble is transmitted by recognition.

In case that the recognition is confirmed between mobile stations desiring a direct communication by the above-described method, the mobile station is able to transmit a request for the direct communication to a base station by utilizing a previous macro cell or a base station link. In particular, when the request for the direct communication is made, a pairing should be correctly done by utilizing information possessed by the mobile station as much as possible. For this, it is preferable that detail information (e.g., time, frequency, resource information, etc.) on a specific recognition signal is delivered by being included in the request.

When a direct communication between mobile stations is performed, a base station, to which detail information (e.g., mobile station pairing, measurement information between mobile stations, etc.) on the actually performed direct communication is not reported, is able to grant the direct communication in a manner of allocating a resource only in response to the direct communication request made by a specific mobile station. In this case, the mobile station having made the request for the direct communication performs the direct communication using the resource allocated by the base station and is then able to return the resource to the base station after completion of the direct communication. In particular, the direct communication request may include a separate ranging type for the direct communication or a separate scheduling request for the direct communication.

Thus, by enabling the direct communication between mobile stations, it is possible to reduce unnecessary power consumption of the mobile stations. Moreover, it is also possible to reduce or remove a role of the base station in simply receiving and forwarding data of the mobile stations.

The setting of a direct communication can be initiated by a mobile station or a base station. And, the setting of a counterpart mobile station in a direct communication can be performed in various ways. In the following description, a method of setting a counterpart mobile station is explained.

First of all, when a specific mobile station requests a direct communication or a base station requests a direct communication of a specific mobile station, the base station is able to inform the corresponding mobile station of information on a direct communication MS list (DC-MS list) that is a list of direct-communication available mobile stations around the specific mobile station. In this case, the DC-MS list can be selected based on a location based service (LBS), a paging group and the like. A subsequent process follows the step of collecting measurement information described in the following description.

Alternatively, a mobile station, which needs a direct communication without a specific DC-MS list can directly follow the step of collecting measurement information described in the following description.

If a mobile station determines to execute a direct communication or receives a request for a direct communication, the corresponding mobile station collects measurement information on neighbor mobile stations and is then able to transmit the collected measurement information to a base station.

A mobile station receives and detects a reference signal, a pilot, a sounding signal and the like, which are transmitted to a base station by mobile stations within a cell, and is then able to measure channel qualities of the neighbor mobile stations. Based on this information, the mobile station is able to transmit channel quality information of the direct communication candidate mobile stations in good channel status or the measured channel quality information of all the mobile stations to the base station.

A mobile station, which made a request for a direct communication or received the request for the direct communication, transmits a direct communication request signal and a reference signal, a pilot or a sounding signal for channel estimation with neighbor mobile stations to the neighbor mobile stations. And, the mobile station having received the direct communication request and the reference signal simultaneously transmits the estimated data or the information on a channel quality to the base station.

A mobile station, which made a request for a direct communication or received the request for the direct communication, transmits a specific signal via a region allocated by a base station. Each mobile station capable of the direct communication within a macro cell detects the specific signal from the region. If a power, a quality or the like of the detected specific signal is equal to or higher than a specific level, the corresponding mobile station informs the base station of a presence or non-presence of a signal detection and a parameter associated with at least one of the detected value (e.g., power, quality, etc.). The base station is able to determine a target mobile station, which will perform the direct communication with the former mobile station having made the request, in accordance with the reports made by the mobile stations. In doing so, every mobile station is able to detect the specific signal or mobile stations belonging to a specific group can detect the specific signal only. For instance, the mobile stations belonging to the specific group can be selected by the base station from mobile stations predicted a located around or neighbor to the former mobile station having requested the direct communication based on the LBS or a paging group. If this mobile station group is used, it is able to reduce unnecessary detection of mobile stations.

A mobile station, which made a request for a direct communication or received the request for the direct communication, performs a simple energy detection on signals transmitted by mobile stations to a base station in a specific time interval or a signal transmitted by the base station to the mobile stations. Subsequently, the mobile station transmits information including an order of a detected energy quantity to the base station. Having received this information, the base station can be aware of the mobile stations, which used to use a region for receiving a signal with high energy from the mobile station, using the order of the energy quantity detected by the mobile station. Using a power control associated parameter and MCS level used for the mobile stations, the base station predicts interference in the channel and is then able to determine a mobile station, which has used the region receivable by the request mobile station with high energy despite excluding the interference, as a direct communication target mobile station.

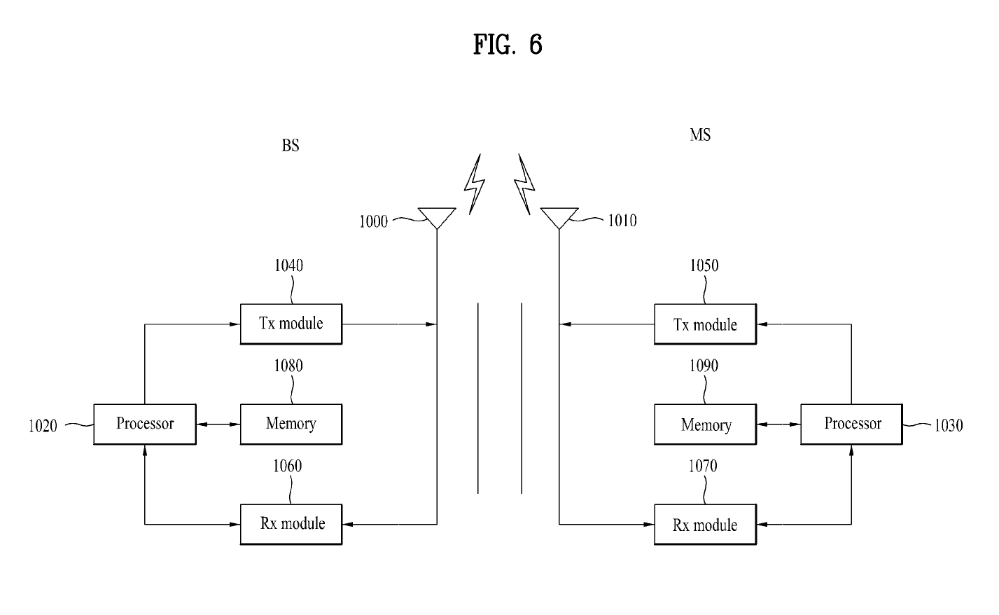

FIG. 6 is a diagram for configurations of mobile and base stations, in which embodiments of the present invention are implemented, according to another embodiment of the present invention.

Referring to FIG. 6, a mobile station/base station (AMS/ABS) includes an antenna 1000/1010 capable of transmitting and receiving information, data, signals and/or messages and the like, a transmitting module (Tx module) 1040/1050 transmitting a message by controlling the antenna 1000/1010, a receiving module (Rx module) 1060/1070 receiving a message by controlling the antenna 1000/1010, a memory 1080/1090 storing informations associated with communication with a base station, and a processor 1020/1030 controlling the transmitting module 1040/1050, the receiving module 1060/1070 and the memory 1080/1090. In this case, the base station can include a femto base station or a macro base station.

The antenna 1000/1010 externally transmits a signal generated from the transmitting module 1040/1050. And, the antenna 1000/1010 receives a radio signal from outside and then delivers the received radio signal to the receiving module 1060/1070. In case that a multiple-antenna (MIMO) function is supported, at least two antennas can be provided to the mobile station or the base station.

The processor 1020/1030 generally controls overall operations of the mobile/base station. In particular, the processor 1020/1030 is able to perform a control function for performing the above-described embodiments of the present invention, a MAC (medium access control) frame variable control function according to service characteristics and propagation environment, a handover function, an authentication function, an encryption function and the like. And, the processor 1020/1030 can further include an encryption module configured to encrypt various messages and a timer module configured to control transmission and reception of the various messages.

The transmitting module 1040/1050 performs prescribed coding and modulation on a signal and/or data, which is scheduled by the processor and will be then transmitted externally, and is then able to deliver the coded and modulated signal and/or data to the antenna 1000/1010.

The receiving module 1060/1070 reconstructs the radio signal received externally via the antenna 1000/1010 into original data in a manner of performing decoding and demodulation on the received radio signal and is then able to deliver the reconstructed original data to the processor 1020/1030.

The memory 1080/1090 can store programs for processing and control of the processor and is able to perform a function of temporarily storing input/output data (e.g., in case of the mobile station, UL grant allocated by the base station, system information, station identifier (STID), a flow identifier (FID), an action time, region allocation information, frame offset information, etc.).

And, the memory 1080/1090 can include at least one of storage media including a flash memory, a hard disk, a multimedia card micro type memory, a memory card type memory (e.g., SD memory, XD memory, etc.), a RAM (random access memory), an SRAM (static random access memory), a ROM (read-only memory), an EEPROM (electrically erasable programmable read-only memory), a PROM (programmable read-only memory), a magnetic memory, a magnetic disk, an optical disk and the like.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents. For instance, the respective configurations disclosed in the aforesaid embodiments of the present invention can be used by those skilled in the art in a manner of being combined with one another.

Therefore, the present invention is non-limited by the embodiments disclosed herein but intends to give a broadest scope matching the principles and new features disclosed herein.

What is claimed is:

1. A method for performing a direct communication, which is performed by a first terminal in a wireless communication system, comprising the steps of:
receiving a resource allocation information on a resource allocated to the direct communication from a base station; and
performing the direct communication with a second terminal using the allocated resource, wherein the allocated resource is defined in either an uplink resource region of the base station or a downlink resource region of the base station and divided into a transmission region and a receipt region for the direct communication.

2. The method of claim 1, wherein the allocated resource is reused for a communication between the base station and a third terminal.

3. The method of claim 1, wherein the allocated resource is reused for a direct communication between a third terminal and a fourth terminal.

4. The method of claim 1, further comprising the steps of:
performing a channel quality measurement on neighbor terminals;
transmitting a result of the measurement to the base station; and
receiving an information on the second terminal to perform the direct communication with the first terminal from the base station, wherein the second terminal is determined using the measurement information.

5. The method of claim 4, further comprising the step of receiving a list of the neighbor terminals from the base station.

6. The method of claim 1, further comprising the steps of:
transmitting a first channel for informing neighbor terminals of an existence of the first terminal; and
receiving a second channel from the second terminal in response to the first channel.

7. The method of claim 1, further comprising the step of transmitting a direct communication request to the base station.

8. A method of supporting a direct communication in a base station of a wireless communication system, comprising the steps of:
determining a resource allocated to the direct communication in a manner of defining a resource region to use for the direct communication on either an uplink resource region and a downlink resource region and dividing the defined resource region into a transmission region and a receipt region for the direct communication; and
transmitting a resource allocation information on the allocated resource to a first terminal.

9. The method of claim 8, wherein the allocated resource is reused for a communication between the base station and a second terminal.

10. The method of claim 8, wherein the allocated resource is reused for a communication between a second terminal and a third terminal.

11. The method of claim 8, further comprising the steps of:
receiving a measurement information on neighbor terminals of the first terminal from the first terminal; and
informing the first terminal of a fourth terminal to perform the direct communication with the first terminal by determining the fourth terminal using the measurement information.

12. The method of claim 11, further comprising the step of transmitting a list of the neighbor terminals to the first terminal.

14. The method of claim 8, further comprising the step of receiving a direct communication request message requesting for performing a communication with a neighbor terminal directly from the first terminal.

15. A first terminal in a wireless communication system, comprising:
a receiving module configured to receive a resource allocation information on a resource allocated to a direct communication from a base station; and
a processor configured to perform the direct communication with a second terminal using the allocated resource,
wherein the allocated resource is defined in either an uplink resource region of the base station or a downlink resource region of the base station and divided into a transmission region and a receipt region for the direct communication.

16. The first terminal of claim 15, wherein the allocated resource is reused for a communication between the base station and a third terminal.

17. The first terminal of claim 15, wherein the allocated resource is reused for a direct communication between a third terminal and a fourth terminal.

18. The first terminal of claim 15, further comprising a transmitting module configured to transmit a direct communication request to the base station.

19. A base station in a wireless communication system, comprising:
a processor configured to determine a resource allocated to the direct communication in a manner of defining a resource region to use for the direct communication on either an uplink resource region and a downlink resource region and dividing the defined resource region into a transmission region and a receipt region for the direct communication; and
a transmitting module configured to transmit a resource allocation information on the allocated resource to a first terminal.

20. The base station of claim 19, wherein the allocated resource is reused for a communication between the base station and a second terminal.

21. The base station of claim 19, wherein the allocated resource is reused for a communication between a second terminal and a third terminal.
